(19) United States
(12) Patent Application Publication
(10) Pub. No.: US 2009/0252368 A1
(43) Pub. Date: Oct. 8, 2009

(54) Ribbon transducer with improved dispersion, excursion and distortion characteristics

(75) Inventor: George E. Short, III, Old Forge, NY (US)

Correspondence Address: GEORGE E. SHORT III, P.O. BOX 534, OLD FORGE, NY, 13420, US

(73) Assignee: GEORGE E. SHORT, III, Old Forge, NY (US)

(21) Appl. No.: 12/080,412

(22) Filed: Apr. 2, 2008

(51) Int. Cl. H04R 1/00

(52) U.S. Cl. 381/398; 381/399

(57) ABSTRACT

A ribbon-type electroacoustic transducer such that the acoustic dispersion in the window roughly parallel to the transducers' diaphragm surface is superior to the dispersion of other similar ribbon-type electroacoustic transducers is described. In addition, methods of improving the symmetry of the magnetic field within the motor of the electroacoustic transducer are described. In addition, methods of employing flexible suspension elements attached to a ribbon-type electroacoustic transducer diaphragm such that a shape is created in the diaphragm by the compliance of the flexible suspension elements roughly approximating a smooth curve similar to the smoothly curved diaphragm as described above is described.

Additionally, methods of improving the symmetry of the magnetic field within the motor for this shape of diaphragm are described.

Additionally, a type of material employed for the flexible suspension which offers minimal acoustic interference to sound radiated from the diaphragm and minimal compromise of the transducers' low frequency performance is described.

### CROSS REFERENCE TO RELATED APPLICATIONS

1) Ribbon Transducer with Improved Excursion and Dispersion Characteristics; assigned to George E. Short III of Old Forge, N.Y., U.S. patent Office application Ser. No. 11/799,246; Filed May 1, 2007

### BACKGROUND OF THE INVENTION

The invention was conceived of, designed and constructed as an electroacoustic transducer which displays improvement in dispersion, excursion and distortion over existing designs.

This type of electroacoustic transducer is usually referred to as a “ribbon” transducer and is generally used for audio reproduction applications as a high frequency, mid-frequency or full range unit.

Conventional ribbon transducer designs employ a diaphragm made of conductive material or film adhered to conductive material suspended between two straight parallel rows of magnets which create a magnetic field. The diaphragm may or may not be corrugated. Interaction between alternating current flow though the conductive material and the magnetic field causes the conductive material and therefore the diaphragm to vibrate. (FIG. 1 and FIG. 2).

Conventional ribbon transducer designs have excursion limitations caused by small variations in the magnetic field and small variations in tension along the diaphragm length. Under high excursion, conventional ribbon transducers invariably twist or flutter, causing audible and measurable distortion.

The acoustic radiation pattern of the front and back of conventional ribbon transducer designs are very similar to that of a finite line source, and therefore conventional ribbon transducer designs exhibit a “preferred listening” axis which is an axis orthogonal to the diaphragm surface and roughly bisects the diaphragm along its longest dimension. Above and below this “preferred listening” axis, the measured and perceived frequency response of the transducer is unsatisfactory when compared with the measured and perceived frequency response of the transducer on this “preferred listening” axis (FIG. 2).

Some past designs have attempted to overcome the limitation of a single “preferred listening” axis by adding a single fixed support rigidly attached to the diaphragm which creates a permanent bend in the diaphragm, thereby effectively creating two shorter diaphragms, each with its own “preferred listening” axis (FIG. 3). The drawback of this approach is that the maximum amount of air volume that can be displaced by the motion of the diaphragm (that is, the product of the diaphragm's net surface area and the diaphragms maximum motion perpendicular to its surface area) is reduced because of the additional rigid attachment to the support. Because the low frequency performance limit of the transducer is proportional to the amount of air volume the diaphragm can displace, the low frequency performance is compromised by employing this rigid support approach.

Other past designs have used a series of shorter individual ribbon transducers, at least one of which is mounted at a different angle than the others, to create a secondary and additional “preferred listening axes”. As with the rigid support approach described above, the multiple short ribbon approach also has compromised low frequency performance.

### BRIEF DESCRIPTION OF THE INVENTION

In this invention, the ribbon diaphragm is suspended at three or more positions along its length such that the diaphragm is shaped into several shorter, straight sections such that, when viewed on edge, the shape of the diaphragm approximates a diaphragm which is smoothly curved along its length. When in motion, this uniquely shaped diaphragm creates an acoustic wave front with superior dispersion compared to that of a conventional straight ribbon.

The suspension elements may be made of a flexible material such that they act as flexible suspension elements, and may also be made of particular materials which offer minimal acoustic resistance and may aid in centering the diaphragm within the motor.

As another aspect of this invention, the permanent magnets employed to create the static magnetic field within the ribbon motor may be shaped and/or positioned in such a way that the mimic the curve-like shape of the diaphragm, such that they distribute the magnetic field more symmetrically in front of and behind the ribbon diaphragm, resulting in more symmetric motion of the diaphragm while driven by an alternating electrical current. Hence the ribbon diaphragm exhibits superior excursion characteristics while the resulting acoustic radiation created by the diaphragm in motion exhibits lower distortion.

### DETAILED DESCRIPTION OF THE INVENTION

In this invention, the ribbon diaphragm is suspended at three or more positions along its length such that the diaphragm is shaped into several shorter, straight sections such that, when viewed on edge, the shape of the diaphragm approximates a diaphragm which is smoothly curved along its length (FIG. 4). When in motion, this uniquely shaped diaphragm creates an acoustic wave front with superior dispersion compared to that of a conventional straight ribbon.

The suspension elements may be made of a flexible material such that they act as flexible suspension elements, and may also be made of particular materials which offer minimal acoustic resistance and may aid in centering the diaphragm within the motor (FIG. 5). The compliance of the suspension elements allows for some motion of the diaphragm at the points of attachment. In the case of flexible suspension elements, It is the compliance force of the suspension elements on the diaphragm which create numerous shorter, straight sections in the ribbon diaphragm, while the ribbon diaphragm begins to take on a roughly curved shape approximating the smooth curve of the curved ribbon diaphragm described above (FIG. 4).

When in motion, this uniquely shaped diaphragm creates an acoustic wave front with superior dispersion compared to that of a conventional straight ribbon. While the acoustic wave front of a conventional straight ribbon resembles that of a cylindrical wave front with a single preferred listening axis, the acoustic wave front created by the curved ribbon just described has a large number of preferred listening axis, and as the curvature of the ribbon diaphragm increases the wave front begins to resemble the curved shape of the ribbon itself. For example, a curved ribbon as described where the curve approximates a section of circular arc, the acoustic wave front created by the ribbon in motion closely resembles that of a narrow slice of a spherical wave front (referred to as an “orange segment” wavefront, since the surface of the wave front resembles the outer surface of a segment of the orange fruit) (FIG. 6), where the virtual source of the spherical wave front is a point source located at the center of a the circle roughly defined by circular arc segment shape of the ribbon diaphragm (FIG. 7). The shape of the wave front exhibits wider dispersion of the convex side of the diaphragm and more focussed dispersion on the concave side, both characteristics which could be considered superior to that of the finite line source cylindrical wave front radiated by a conventional, straight ribbon.

Because the acoustic wave front created by the curved ribbon diaphragm in motion resembles that of a section of a spherical wave front, the measured and perceived high frequency performance is similar throughout the window roughly defined the section of spherical wave font as the wave front travels in front of and behind the diaphragm.

The convexity of the diaphragm is approximated by the maximum internal angle between any two planes defined by the straight sections of the diaphragm's surface while the diaphragm is at rest. If the maximum internal angle between any two planes is equal to or less than 177.6 degrees, the ribbon diaphragm will exhibit improved dispersion similar to that of a smoothly curved ribbon (FIG. 8).

As another aspect of this invention, the permanent magnets employed to create the static magnetic field within the ribbon motor may be shaped and/or positioned in such a way that they distribute the magnetic field more symmetrically in front of and behind the ribbon diaphragm along the curved shape of the diaphragm defined while the diaphragm is at rest. This may be accomplished by using magnets which themselves exhibit a curved shape similar to the curved shape of the curved ribbon diaphragm, or a series of magnets with are offset in depth, angle, or both along the length of the ribbon diaphragm such that the magnetic field exhibits superior symmetry in front of and behind the ribbon diaphragm than can be obtained by a conventional, straight row of magnets, while the diaphragm is at rest. The superior symmetry of the magnetic field in front of and behind the ribbon diaphragm results in more symmetric motion of the diaphragm while driven by an alternating electrical current, hence the ribbon diaphragm exhibits superior excursion characteristics while the resulting acoustic radiation created by the diaphragm in motion exhibits lower distortion (FIG. 9).

Another aspect of this variation of the invention is that the suspension material employed may be made of a loosely woven material (such as a section of flexible screen) such that the suspension material has minimum interference with the sound waves radiated by the diaphragm (FIG. 5).

Another aspect of this variation of the invention is that torsional stiffness of some or all of the suspension elements may also assist in centering the diaphragm in the magnetic gap and preventing it from twisting or fluttering during its motion. (FIG. 5).

### BRIEF DESCRIPTION OF THE DRAWINGS

FIG. 1) Front view of a conventional ribbon transducer

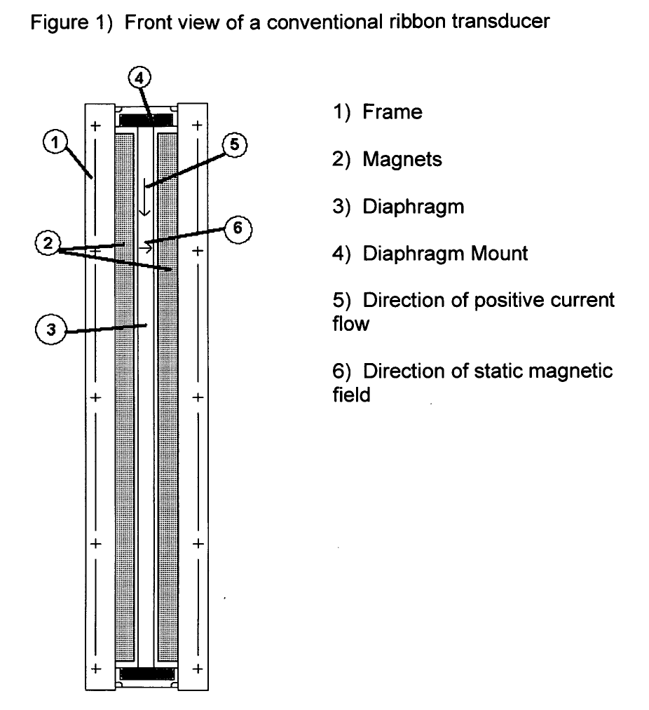

FIG. 2) Side cross-section view of a conventional ribbon transducer

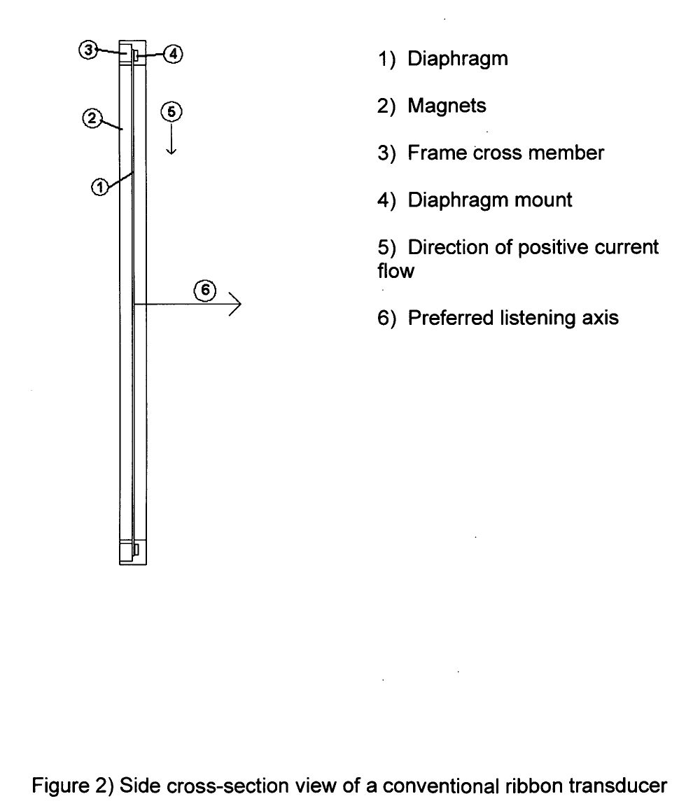

FIG. 3) Side cross-section view of a conventional ribbon transducer with fixed support and additional “preferred listening axis”.

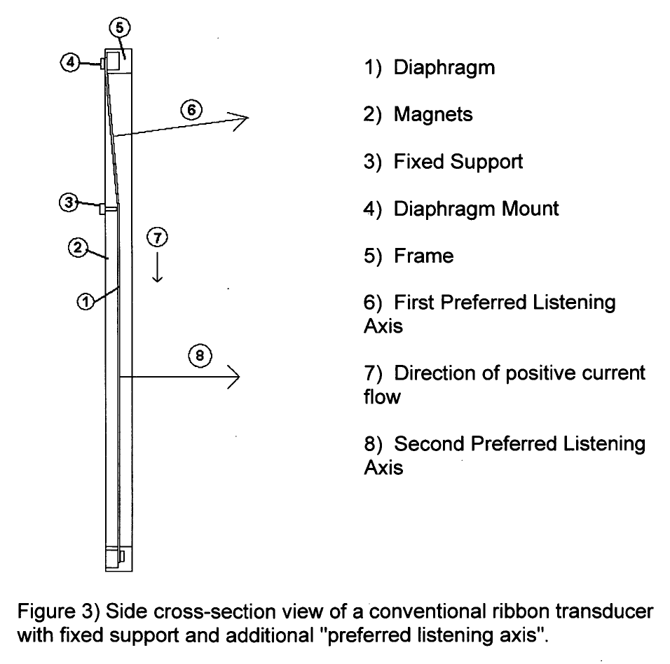

FIG. 4) Side view of the invention showing three suspension elements and additional preferred listening axi.

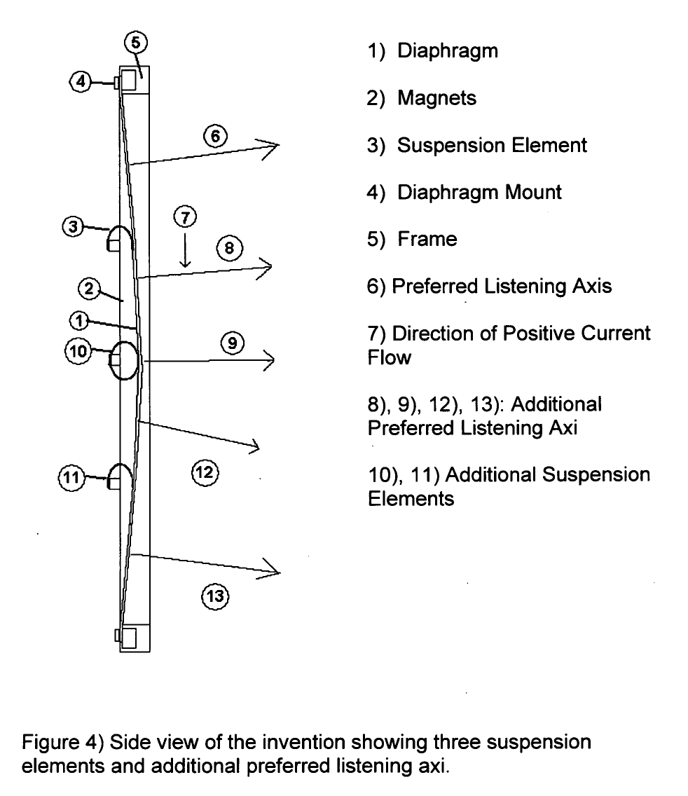

FIG. 5) Top cross section view of the invention showing close up of compliant suspension element.

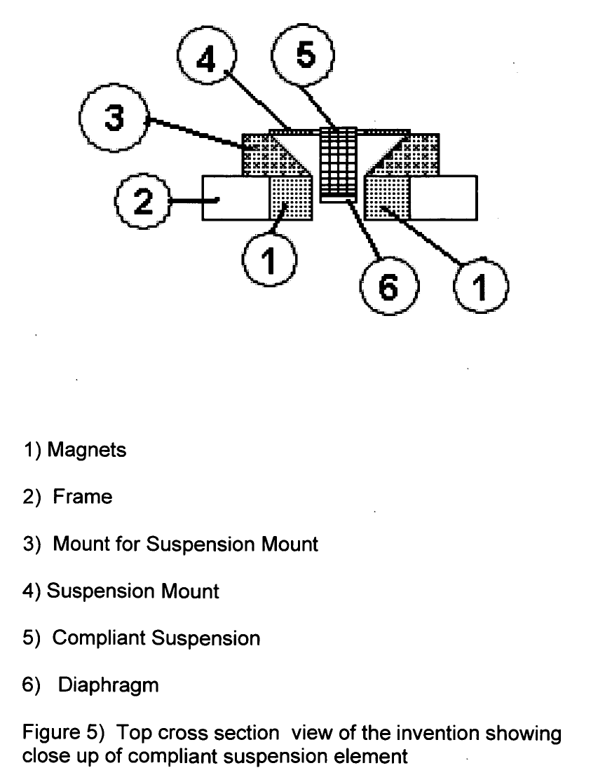

FIG. 6) Side angle view of the invention showing the “orange segment” wave-front.

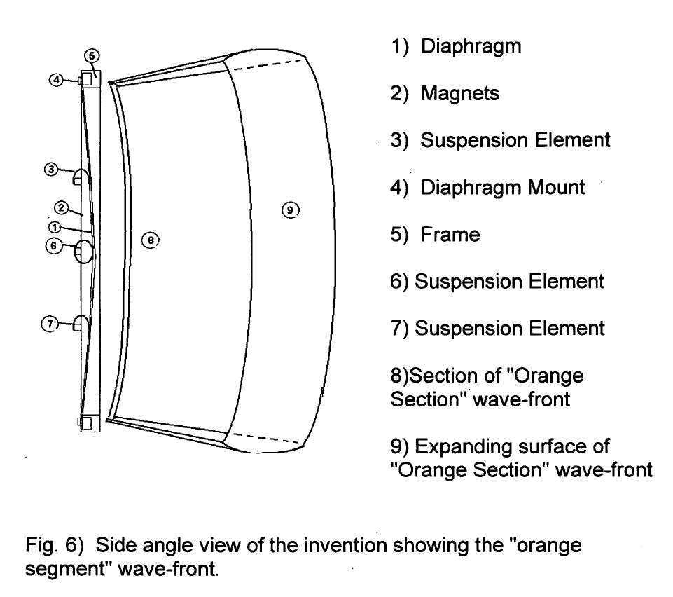

FIG. 7) Side angle view of the invention showing the “orange segment” wave-front and location of wave-front's virtual source.

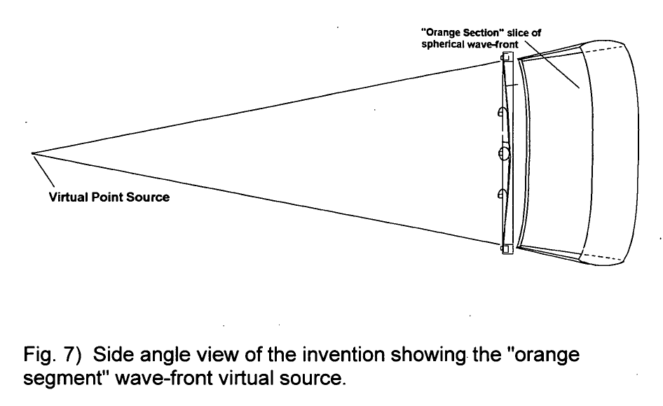

FIG. 8) Side view of the invention showing the internal angle defined by two straight sections of the ribbon diaphragm.

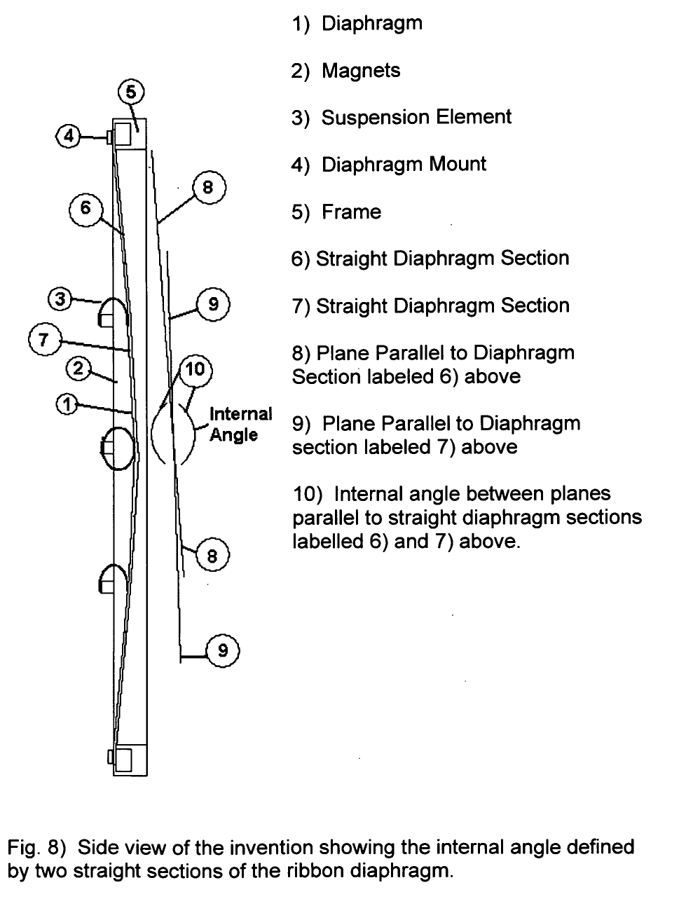

FIG. 9) Side view of the inventions showing the mounting positions of the magnets.

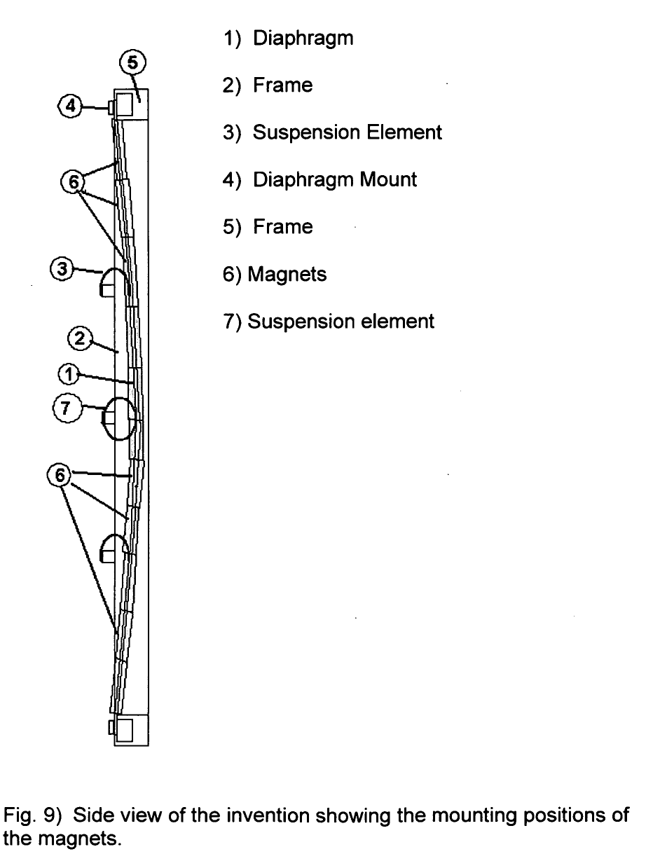

1) This invention may employ three or more suspension elements attached to the ribbon diaphragm along its length. The diaphragm takes on a shape roughly approximating a curved shape similar to that of the smoothly curved diaphragm. As long as the internal angle between any two of the planes defined by the straight sections of the ribbon diaphragm is less than or equal to 177.6 degrees, the ribbon transducer will exhibit superior dispersion characteristics.

2) A variation of this invention may employ permanent magnets within the ribbon transducer motor such which are shaped and/or positioned in such a way that the shape or positions of the magnets mimics the curved shape of the ribbon diaphragm, and aids in creating a more symmetric magnetic field in front of and behind the curved ribbon diaphragm while the diaphragm is at rest. This may employ magnets which themselves are curved, or a series of magnets that are positioned offset within the motor in depth, angle, or both along the length of the ribbon diaphragm such that the magnetic field in front of and behind the diaphragm is more symmetric than can be obtained by a conventional, straight row of magnets, while the ribbon diaphragm is at rest. The improved symmetry of the magnetic field results in more symmetric motion of the ribbon diaphragm while driven by an alternating electrical current, hence the ribbon diaphragm exhibits superior excursion characteristics while the resulting acoustic radiation created by the diaphragm in motion exhibits lower distortion.

3) A variation of this invention is that the ribbon diaphragm may be attached to a flexible suspension element made from material which exhibits torsional stifess in such a way that it centers the diaphragm in the magnetic gap and prevents the diaphragm from twisiting out of the plane defined by the diaphragm's surface during diaphragm motion.

4) This invention is unique in that an improved dispersion pattern is achieved.

5) This invention is unique in that the improved dispersion pattern is achieved while compromises in the low frequency performance of the transducer are minimized.

6) This invention is unique in that a more symmetric magnetic field around the uniquely shaped diaphragm is achieved.

7) this invention is unique in that lower acoustic distortion is achieved.
